(19) United States
(12) Patent Application Publication
(10) Pub. No.: US 2006/0238019 A1
(43) Pub. Date: Oct. 26, 2006

(54) Brakable wheel hub device

(76) Inventor: Mark Yu, Taichung City (TW)

Correspondence Address: MERCHANT & GOULD PC, P.O. BOX 2903, MINNEAPOLIS, MN, 55402-0903, US

(21) Appl. No.: 11/112,405

(22) Filed: Apr. 21, 2005

(51) Int. Cl. B60B 1/00

(52) U.S. Cl. 301/105.1

(57) ABSTRACT

A brakable wheel hub device includes a wheel hub shell having annular mount and anchored regions on an outer surrounding shell surface, and a surrounding flange which extends from the anchored region outwardly and radially and which has a plurality of axially extending insert slots. A coupling sleeve is sleeved on the mount region, and has a coupled region extending to terminate at a surrounding boundary. A plurality of protrusions extend leftward from the surrounding boundary, and are respectively fitted into the insert slots to establish a splined engagement. A brake disk includes a coupling region disposed to be brought into a splined engagement with the coupled region of the coupling sleeve. A surrounding locking member includes an insert segment which engages threadedly the hub shell, and an abutting segment which abuts against the brake disk.

### BACKGROUND OF THE INVENTION

1. Field of the Invention

This invention relates to a brakable wheel hub device, more particularly to a brakable wheel hub device with a wheel hub shell which is suitable for different types of brake disks.

2. Description of the Related Art

Referring to FIG. 1, a conventional brakable wheel hub device 1 is shown to include a hub shell 11 which has a plurality of teeth 12 formed at an end 111 thereof, a coupling sleeve 13 which has a plurality of teeth 132 disposed to be brought into a splined engagement with the teeth 12 of the wheel hub shell 11, and a plurality of screw holes 131 formed therein such that a plurality of screw fasteners 14 pass through a plurality of through holes 34 in a brake disk 3 and engage threadedly the screw holes 131 so as to secure the brake disk 3 to the coupling sleeve 13, and a locking member 15 which has a threaded insert segment engaging threadedly a threaded surface of the end 111, and an abutting segment abutting against the brake disk 3 so as to secure the brake disk 3 to the wheel hub shell 11.

Referring to FIG. 2, another conventional brakable wheel hub device includes a hub shell 21 which has a plurality of teeth 22 formed at an end 211 thereof to be brought into a splined engagement with teeth 41 formed on a brake disk 4, and a locking member 23 which engages threadedly the end 211 and which abuts against the brake disk 4.

Since each of the hub shells 11, 21 of the aforesaid conventional wheel hub devices has the teeth 12, 22 formed thereon, it is not suitable for use with different types of brake disks 3, 4. For example, if the brake disk 3, 4 has a relatively large or small axial hole relative to the end 111, 211 of the hub shell 11, 21, it is not possible for the user to mounted the same on the hub shell 11, 21.

### SUMMARY OF THE INVENTION

The object of the present invention is to provide a brakable wheel hub device having a wheel hub shell suitable for different types of brake disks, which is economical to manufacture, and which allows for convenient assembly of a brake disk to the wheel hub shell.

According to this invention, the breakable wheel hub device includes a wheel hub shell which is adapted to be rotatably mounted on an axle of a bicycle about an axis in an axial direction, and which has left and right opened ends opposite to each other along the axis. The wheel hub shell includes inner and outer surrounding shell surfaces which are opposite to each other in radial directions relative to the axis, and which are joined by the right opened end. The outer surrounding shell surface includes an annular mount region and an annular anchored region proximate to and distal from the right opened end respectively. The inner surrounding shell surface has an inner surrounding threaded section proximate to the right opened end. A surrounding flange extends from the annular anchored region outwardly and in the radial directions, and terminates at an outer peripheral edge which is adapted to anchor a plurality of spokes of a bicycle. The surrounding flange has a plurality of insert slots which are angularly displaced from one another about the axis, and which extend in the axial direction. A coupling sleeve includes inner and outer coupling wall surfaces opposite to each other in the radial directions. The inner coupling wall surface is configured to be sleeved on the annular mount region. The outer coupling wall surface includes a coupled region extending leftwards to terminate at a surrounding boundary. A plurality of protrusions extend leftward from the surrounding boundary, and are angularly displaced from one another about the axis to respectively mate with the insert slots such that when the inner coupling wall surface is sleeved on the annular mount region, the protrusions are respectively fitted into the insert slots to establish a splined engagement. A brake disk has an inner peripheral wall which surrounds the axis to define a through hole adapted for passage of the axle therethrough, and which extends rightwards to terminate at a surrounding edge, and a surrounding abutment wall surface which extends from the surrounding edge outwardly and in radial directions. The brake disk includes a coupling region which is disposed on one of the inner peripheral wall and the surrounding abutment wall surface, and which is configured such that the coupling region is brought into a splined engagement with the coupled region. A surrounding locking member includes an insert segment which has an outer insert surface surrounding the axis and formed with an outer surrounding threaded section to engage threadedly the inner surrounding threaded section, and an abutting segment which extends radially from the outer insert surface of the insert segment, and which abuts against the surrounding abutment wall surface.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 is an exploded perspective view of a conventional brakable wheel hub device;

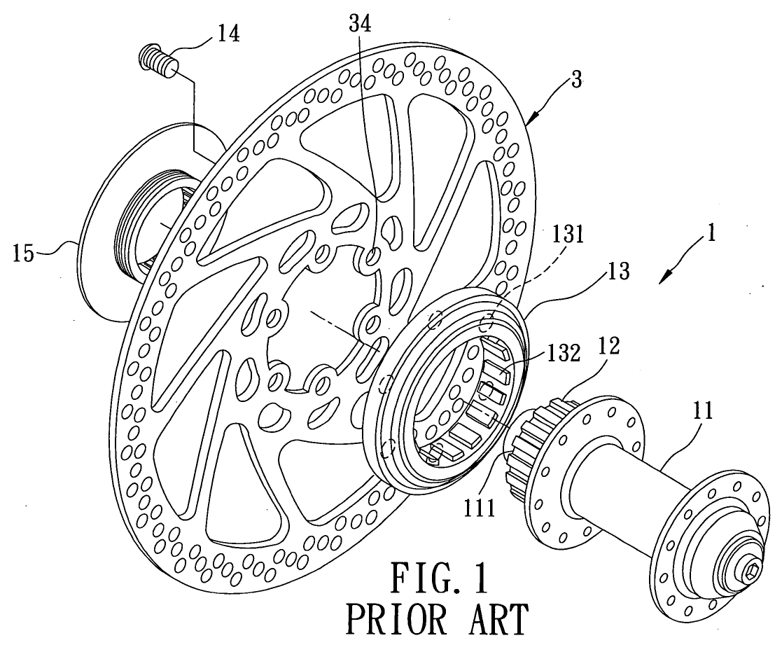

FIG. 2 is an exploded perspective view of another conventional brakable wheel hub device;

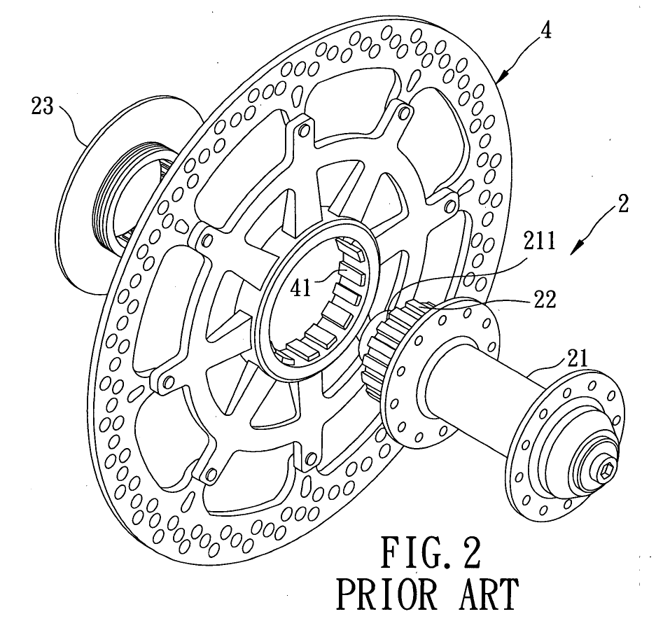

FIG. 3 is an exploded perspective view of a preferred embodiment of a brakable wheel hub device according to this invention;

FIG. 4 is a perspective view of the preferred embodiment shown in FIG. 3;

FIG. 5 is an exploded perspective view of another preferred embodiment of a brakable wheel hub device according to this invention; and

FIG. 6 is a perspective view of the preferred embodiment shown in FIG. 5.

### DETAILED DESCRIPTION OF THE PREFERRED EMBODIMENTS

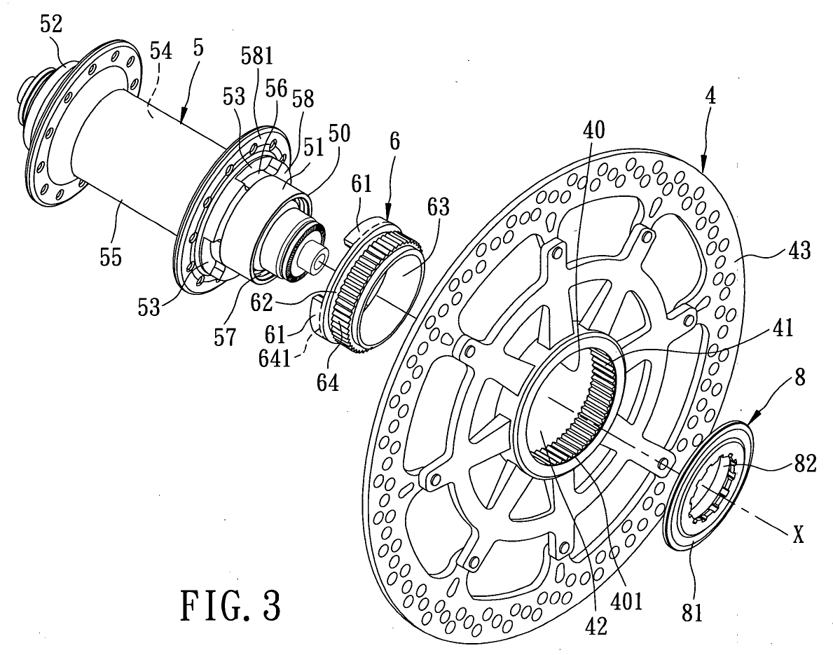

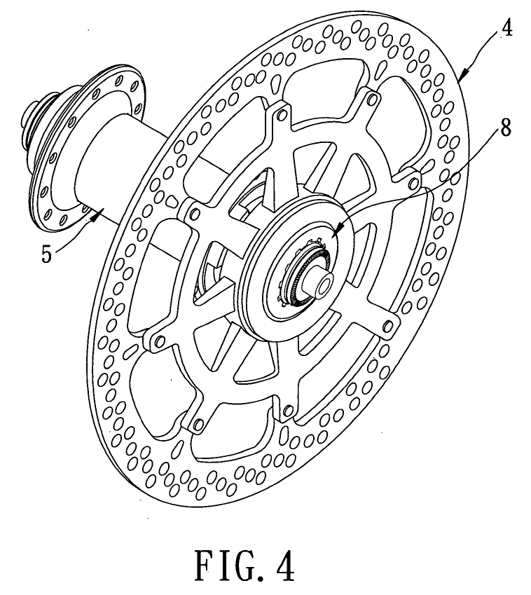

Referring to FIGS. 3 and 4, the preferred embodiment of a brakable wheel hub device according to the present invention is shown to comprise a wheel hub shell 5 which is adapted to be rotatably mounted on a wheel axle of a bicycle (not shown) about an axis (X) in an axial direction, and which has left and right opened ends 52, 50 opposite to each other along the axis (X). The wheel hub shell 5 includes inner and outer surrounding shell surfaces 54, 55 which are opposite to each other in radial directions relative to the axis (X), and which are joined by the right opened end 50. The outer surrounding shell surface 55 includes an annular mount region 51 and an annular anchored region 56 proximate to and distal from the right opened end 50 respectively. The inner surrounding shell surface 54 has an inner surrounding threaded section 57 which is proximate to the right opened end 50.

A surrounding flange 58 is formed integrally with the wheel hub shell 5, extends from the annular anchored region 56 outwardly and in the radial directions, and terminates at an outer peripheral edge 581 which is adapted to anchor a plurality of spokes (not shown) of a bicycle. The surrounding flange 58 has a plurality of insert slots 53 which are angularly displaced from one another about the axis (X), and which extend in the axial direction.

A coupling sleeve 6 includes inner and outer coupling wall surfaces 63, 62 opposite to each other in the radial directions. The inner coupling wall surface 63 is configured to be sleeved on the annular mount region 51. The outer coupling wall surface 62 includes a coupled region 64 which extends leftwards to terminate at a surrounding boundary 641. A plurality of protrusions 61 are formed integrally with and extend leftward from the surrounding boundary 641, and are angularly displaced from one another about the axis (X). The protrusions 61 are configured to respectively mate with the insert slots 53 such that when the inner coupling wall surface 63 is sleeved on the annular mount region 51, the protrusions 61 are respectively fitted into the insert slots 53 to establish a splined engagement therewith.

A brake disk 4 has an inner peripheral wall 40 which surrounds the axis (X) to define a through hole 42 that is adapted for passage of the wheel axle therethrough, and which extends rightwards to terminate at a surrounding edge 401, and a surrounding abutment wall surface 43 which extends from the surrounding edge 401 outwardly and in radial directions. The brake disk 4 includes a coupling region 41 which is disposed on the inner peripheral wall 40 and which is configured such that the coupling region 41 is brought into a splined engagement with the coupled region 64. In this embodiment, the coupled region 64 of the coupling sleeve 6 has a plurality of teeth angularly displaced from one another about the axis (X) and extending in the axial direction. The coupling region 41 of the brake disk 4 has a plurality of teeth angularly displaced from one another about the axis (X) and each extending in the axial direction so as to be brought into a splined engagement with the teeth of the coupled region 64.

A surrounding locking member 8 includes an insert segment 82 which has an outer insert surface that surrounds the axis (X), and that is formed with an outer surrounding threaded section to engage threadedly the inner surrounding threaded section 57, and an abutting segment 81 which extends radially from the outer insert surface of the insert segment 82, and which abuts against the surrounding abutment wall surface 43 when the outer surrounding threaded section engages threadedly the inner surrounding threaded section 57.

In assembly, the inner coupling wall surface 63 of the coupling sleeve 6 is sleeved on the annular mount region 51 with the protrusions 61 respectively fitted into the insert slots 53. The teeth of the coupling region 41 of the brake disk 4 are brought into a splined engagement with the teeth of the coupled region 64. The outer surrounding threaded section of the insert segment 82 of the locking member 8 engages threadedly the inner surrounding threaded section 57 such that the abutting segment 81 abuts against the surrounding abutment wall surface 43. Thus, the brake disk 4 can be secured relative to the wheel hub shell 5, as shown in FIG. 4.

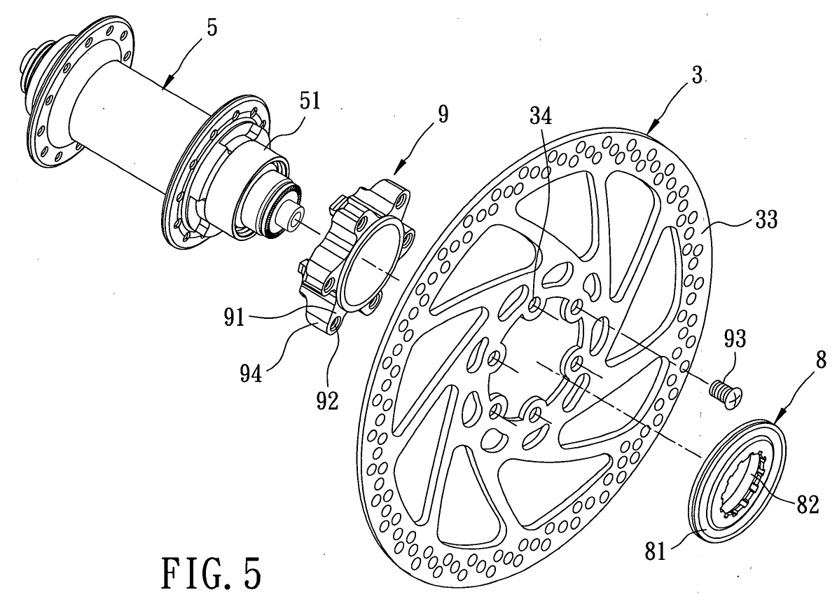

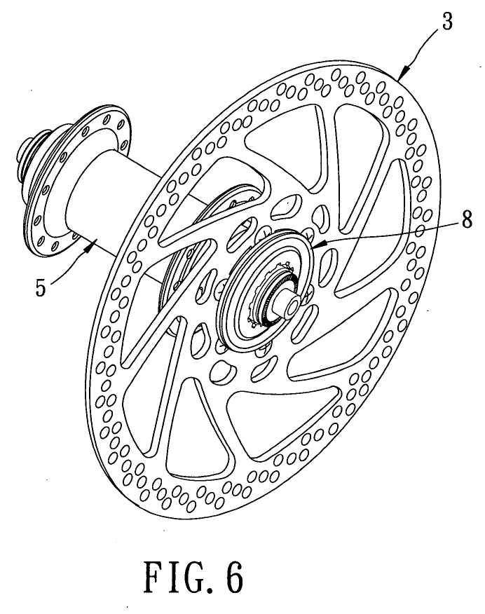

Referring to FIGS. 5 and 6, in an alternative embodiment, the brakable wheel hub device according to this invention includes a coupling sleeve 9 which differs from the coupling sleeve 6 in that the coupled region 94 of the coupling sleeve 9 has a plurality of lugs 91 which are angularly displaced from one another about the axis, which extend in the axial direction, and which are formed with a plurality of threaded bores 92, respectively, and a brake disk 3 of the type shown in FIGS. 5 and 6 having a coupling region which is disposed on a surrounding abutment wall surface 33 and which has a plurality of through holes 34 that are angularly displaced from one another about the axis and each of that extends in the axial direction. A plurality of threaded fasteners 93 are disposed to respectively pass through the through holes 34 in the brake disk 3 and engage threadedly the threaded bores 92 so as to secure the brake disk 3 to the coupling sleeve 9, as shown in FIG. 5.

Thus, it has been shown that the wheel hub shell 5 can couple with the brake disks 4, 3 through the use of coupling sleeves 6, 9, respectively. There is no need to replace the wheel hub shell 5 or to design a new mold for the wheel hub shell 5, thereby rendering the manufacture of the wheel hub device economical, and facilitating assembly of the brake disk 4, 3 to the wheel hub shell 5.

While the present invention has been described in connection with what is considered the most practical and preferred embodiments, it is understood that this invention is not limited to the disclosed embodiments but is intended to cover various arrangements included within the spirit and scope of the broadest interpretations and equivalent arrangements.

I claim:

1. A brakable wheel hub device comprising:
a wheel hub shell which is adapted to be rotatably mounted on an axle of a bicycle about an axis in an axial direction, and which has left and right opened ends opposite to each other along the axis, said wheel hub shell including inner and outer surrounding shell surfaces which are opposite to each other in radial directions relative to the axis, and which are joined by said right opened end, said outer surrounding shell surface including an annular mount region and an annular anchored region proximate to and distal from said right opened end respectively, said inner surrounding shell surface having an inner surrounding threaded section which is proximate to said right opened end;
a surrounding flange disposed to extend from said annular anchored region outwardly and in the radial directions and terminating at an outer peripheral edge which is adapted to anchor a plurality of spokes of a bicycle, said surrounding flange having a plurality of insert slots which are angularly displaced from one another about the axis, and which extend in the axial direction;
a coupling sleeve including inner and outer coupling wall surfaces opposite to each other in the radial directions, said inner coupling wall surface being configured to be sleeved on said annular mount region, said outer coupling wall surface including a coupled region which extends leftwards to terminate at a surrounding boundary;
a plurality of protrusions which are disposed to extend from said surrounding boundary leftwards, and which are angularly displaced from one another about the axis, said protrusions being configured to respectively mate with said insert slots such that when said inner coupling wall surface is sleeved on said annular mount region, said protrusions are respectively fitted into said insert slots to establish a splined engagement;
a brake disk having an inner peripheral wall which surrounds the axis to define a through hole adapted for passage of the axle therethrough, and which extends rightwards to terminate at a surrounding edge, and a surrounding abutment wall surface which extends from said surrounding edge outwardly and in radial directions, said brake disk including a coupling region which is disposed on one of said inner peripheral wall and said surrounding abutment wall surface, and which is configured such that said coupling region is brought into a splined engagement with said coupled region; and
a surrounding locking member including an insert segment which has an outer insert surface that surrounds the axis, and that is formed with an outer surrounding threaded section to engage threadedly said inner surrounding threaded section, and an abutting segment which extends radially from said outer insert surface of said insert segment, and which abuts against said surrounding abutment wall surface when said outer surrounding threaded section engages threadedly said inner surrounding threaded section.

2. The brakable wheel hub device of claim 1, wherein said coupled region of said coupling sleeve has a plurality of teeth angularly displaced from one another about the axis and extending in the axial direction, said coupling region of said brake disk being disposed on said inner peripheral wall and having a plurality of teeth angularly displaced from one another about the axis and extending in the axial direction so as to be brought into a splined engagement with said teeth of said coupled region.

3. The brakable wheel hub device of claim 1, wherein said coupled region of said coupling sleeve has a plurality of lugs angularly displaced from one another about the axis, extending in the axial direction, and respectively formed with a plurality of threaded bores, said coupling region of said brake disk being disposed on said surrounding abutment wall surface and having a plurality of through holes which are angularly displaced from one another about the axis and which extend in the axial direction, and a plurality of threaded fasteners, each of which is disposed to pass through a respective one of said through holes and to engage threadedly a respective one of said threaded bores so as to secure said brake disk to said coupling sleeve.

4. The brakable wheel hub device of claim 1, wherein said surrounding flange is formed integrally with said wheel hub shell.

5. The brakable wheel hub device of claim 1, wherein said protrusions are formed integrally with said coupling sleeve.
